(19) United States
(12) Patent Application Publication
(10) Pub. No.: US 2022/0084291 A1
(43) Pub. Date: Mar. 17, 2022

(54) AUGMENTED REALITY DISPLAY METHOD AND DEVICE FOR CHIP STRUCTURE, AND READABLE STORAGE MEDIUM

(71) Applicant: Gree Electric Appliances, Inc. of Zhuhai, Zhuhai, Guangdong (CN)

(72) Inventors: Yanliang Wu, Zhuhai, Guangdong (CN); Bo Liang, Zhuhai, Guangdong (CN)

(21) Appl. No.: 17/419,884

(22) PCT Filed: Oct. 9, 2019
(86) PCT No.: PCT/CN2019/110180

§ 371 Date: Jun. 30, 2021

(30) Foreign Application Priority Data
Jan. 2, 2019 (CN) 201910001623.3

(51) Int. Cl. G06T 19/00; G06T 7/33

(52) U.S. Cl. CPC G06T 19/006; G06T 2207/30148; G06T 7/33

(57) ABSTRACT

An augmented reality display method and device for a chip structure, and a readable storage medium. The method comprises: obtaining a circuit model diagram corresponding to a chip structure (S11), the circuit model diagram displaying a three-dimensional circuit model; obtaining a target frame of image and capturing, from the target frame of image, a target area displaying a target structure (S12), the target structure being a part or all of the chip structure displayed on the target frame of image; determining a mapping relationship between the target structure and the circuit model (S13); and generating and displaying, according to the mapping relationship and the target structure, a target circuit model corresponding to the target structure (S14). Therefore, the present invention facilitates understanding the running principle of a chip by people, and improves chip development efficiency and chip authentication efficiency.

This application claims priority to a patent application No. 201910001623.3 filed on Jan. 2, 2019 and titled “AUGMENTED REALITY DISPLAY METHOD AND DEVICE FOR CHIP STRUCTURE, AND READABLE STORAGE MEDIUM”, the entirety of which is hereby incorporated by reference herein.

### TECHNICAL FIELD

The disclosure relates to the field of display, and more particularly, to an augmented reality display method and device for a chip structure, and a readable storage medium.

### BACKGROUND

Current development and application of the chip is based on the textual specification. There are many functional modules of the chip, and each module involves many functional parameters. The textual specification is often hundreds of pages, which makes the application of the chip very difficult and not intuitive, and the R & D and verification of the chip are also very difficult and inefficient. At present, the user, developer, and verifier of the chip have to spend a lot of energy to verify and compare each parameter in the chip specification one by one, and make accurate application only after the correct understanding.

In summary, in related technologies, it takes time and effort for people to understand the operating principle of a chip, resulting in low development efficiency. Augmented Reality (AR) is a technology that calculates the position and angle of the camera image in real time and adds the corresponding image, video, and 3D model. The goal of this technology is to put the virtual world in the real world on the screen, and display it interactively, so as to improve user experience. If the operating principle and process of the chip can be displayed in combination with AR technology, it will be convenient for users to understand the operating principle and process of the chip and improve development efficiency.

Therefore, an urgent problem to be solved in related technologies is to facilitate people to understand the operating principle and process of the chip.

### SUMMARY

The disclosure provides an augmented reality display method and a device for a chip structure, and a readable storage medium, so as to facilitate people to understand the operating principle and process of the chip.

In order to solve the above problems, in an aspect of the disclosure, an augmented reality display method for a chip structure is provided, including:

acquiring a circuit model diagram corresponding to the chip structure, the circuit model diagram displaying a three-dimensional circuit model;

acquiring a target frame image and capturing, from the target frame image, a target area displaying a target structure, the target structure being a part or all of the chip structure displayed in the target frame image;

determining a mapping relationship between the target structure and the circuit model; and

generating and displaying, according to the mapping relationship and the target structure, a target circuit model corresponding to the target structure.

Optionally, determining a mapping relationship between the target structure and the circuit model, including:

capturing a plurality of first feature points from the circuit model as a first point group;

capturing a plurality of second feature points from the target structure as a second point group;

matching the first point group and the second point group using feature points matching algorithm to determine a model view matrix between the target structure and the circuit model; and

characterizing the mapping relationship between the target structure and the circuit model with the model view matrix.

Optionally, capturing a plurality of second feature points from the target structure as a second point group includes:

converting the target frame image into a grayscale image, and capturing the plurality of second feature points from the target structure displayed in the grayscale image as the second point group.

Optionally, generating and displaying, according to the mapping relationship and the target structure, a target circuit model corresponding to the target structure includes:

acquiring an original circuit model corresponding to the target structure from the circuit model diagram;

performing, according to the mapping relationship, affine transformation on the original circuit model to obtain target coordinates of each point of the original circuit model on the view plane of the target frame image; and

generating and displaying, according to the target coordinates, the target circuit model corresponding to the target structure.

Optionally, the method further includes:

displaying one or more of current information, voltage information, resistance information, and on/off state of a switch during operation of the target structure on the target circuit model.

The disclosure further provides an augmented reality display device for a chip structure, including:

a first acquisition unit, configured to acquire a circuit model diagram corresponding to the chip structure, the circuit model diagram displaying a three-dimensional circuit model;

a second acquisition unit, configured to acquire a target frame image and capture, from the target frame image, a target area displaying a target structure, the target structure being a part or all of the chip structure displayed in the target frame image;

an affine transformation unit, configured to determine a mapping relationship between the target structure and the circuit model; and

a model generation unit, configured to generate and display, according to the mapping relationship and the target structure, a target circuit model corresponding to the target structure.

Optionally, determining, by the affine transformation unit, a mapping relationship between the target structure and the circuit model, including:

capturing a plurality of first feature points from the circuit model as a first point group;

capturing a plurality of second feature points from the target structure as a second point group;

matching the first point group and the second point group using feature points matching algorithm to determine a model view matrix between the target structure and the circuit model; and

characterizing the mapping relationship between the target structure and the circuit model with the model view matrix.

Optionally, capturing, by the affine transformation unit, a plurality of second feature points from the target structure as a second point group includes:

converting the target frame image into a grayscale image, and capturing the plurality of second feature points from the target structure displayed in the grayscale image as the second point group.

Optionally, generating and displaying, by the model generation unit, a target circuit model corresponding to the target structure according to the mapping relationship and the target structure includes:

acquiring an original circuit model corresponding to the target structure from the circuit model diagram;

performing, according to the mapping relationship, affine transformation on the original circuit model to obtain target coordinates of each point of the original circuit model on the view plane of the target frame image; and

generating and displaying, according to the target coordinates, the target circuit model corresponding to the target structure.

Optionally, the device further includes: an analog circuit unit, configured to display one or more of current information, voltage information, resistance information, and on/off state of a switch during operation of the target structure on the target circuit model.

The disclosure further provides a readable storage medium, a computer program is stored therein and configured to perform, when executed by a processor, steps in any one of the methods provided in the disclosure.

The disclosure provides an augmented reality display method and device for a chip structure, and a readable storage medium. The target circuit model is generated correspondingly according to the target structure in the target frame image, thereby facilitating people to understand the operating principle of the chip, and improve the chip development efficiency and chip verification efficiency.

### BRIEF DESCRIPTION OF THE DRAWINGS

FIG. 1 illustrates a flowchart of an augmented reality display method for a chip structure according to an embodiment of the disclosure; and

FIG. 2 illustrates a component diagram of an augmented reality display device for a chip structure according to an embodiment of the disclosure.

### DETAILED DESCRIPTION

In order to make the objectives, technical solutions, and advantages of the disclosure clearer, the technical solutions of the disclosure will be described clearly and completely in combination with the specific embodiments of the disclosure and the corresponding drawings. Obviously, the described embodiments are only a part of the embodiments of the disclosure, and are not all of the embodiments thereof. Based on the embodiments of the disclosure, all other embodiments obtained by those of ordinary skill in the art without making creative work shall fall within the protection scope of the disclosure.

It should be noted that, the terms “first”, “second”, and the like in the specification, claims, and drawings of the disclosure are used to distinguish similar objects, and are not necessarily used to describe a specific order or sequence. It should be understood that the sequence used herein can be interchanged under appropriate circumstances so that the embodiments of the disclosure described herein can be implemented in a sequence other than those illustrated or described herein. In addition, the terms “include”, “have”, and any variations of them are intended to cover non-exclusive inclusions. For example, a process, method, system, product, or device that includes a series of steps or units is not necessarily limited to those steps or units clearly listed, and may include other steps or units that are not clearly listed or are inherent to this process, method, product, or device.

In related technologies, after the chip is manufactured, a camera is usually used to take microstructure photos of the chip structure. The researchers compare the microstructure photos with the chip specification used in chip design to understand the operating principle and process of the chip. There are many modules of the chip, and each module has many parameters. Therefore, the development efficiency of this development mode is low, and it takes time and effort for the researchers to understand the operating principle and process of the chip.

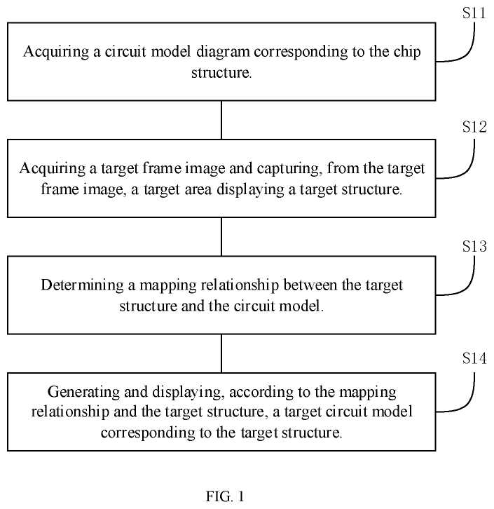

In order to solve the above technical problem, as shown in FIG. 1, the disclosure provides an augmented reality display method for a chip structure, including:

S11: Acquiring a circuit model diagram corresponding to the chip structure.

Specifically, the chip structure is the internal structure of any chip manufactured according to the manufacturing specification, the chip structure may include: resistors, inductors, capacitors, diodes, transistors, thin film transistors, and other components, and wires connecting the components. The circuit model diagram displays a three-dimensional circuit model thereon. The circuit model is a three-dimensional model made according to the manufacturing specification for the chip structure. The circuit model corresponds to the chip structure. Preferably, in the circuit model, each component in the chip is represented by the physical graphic symbol corresponding to the component. For example, the capacitor is represented by “H”, and the resistor is represented by a rectangle. Preferably, the connecting wire length and relative position of the components in the circuit model are the same as those of the components in the chip structure manufactured in the real environment. For example, the length of the connecting wire between two resistors in the chip structure is 1 mm, and the wire between the two resistors in the circuit model is also of 1 mm length, that is, the circuit model can be an isometric three-dimensional schematic diagram with the same size as the chip structure. More preferably, each component in the circuit model is marked with a corresponding physical alphabetic symbol and/or Chinese name thereon, for example, “R” and/or “resistor” are displayed on the resistor, and the physical parameters of each component are preferably displayed at the same time, for example, the resistance value is displayed on the resistor, for another example, “capacitance=10” is displayed on the capacitor to indicate the type of the component and the size of the capacitor, so as to facilitate people's understanding. The purpose of establishing a three-dimensional circuit model is to facilitate users to understand the operating principle and process of each component in the chip structure.

S12: Acquiring a target frame image and capturing, from the target frame image, a target area displaying a target structure.

Specifically, after a chip with the above chip structure is manufactured in the real environment, the internal structure of the manufactured chip will be photographed with the camera's photographic equipment. The photo taken by the camera is the target frame image, and the internal structure of the chip is the chip structure in the disclosure. A high-magnification camera is usually needed to photograph the internal structure of the chip. The target frame image here is any photo of the internal structure of a chip manufactured in the real environment, and the chip has the chip structure described in the disclosure. Therefore, a part or all of the chip structure must be displayed on the photographed target frame image. The target area is the area where the chip structure is displayed, and the chip structure displayed in the target frame image is referred to as the target structure in the disclosure, that is, the target structure is a part or all of the chip structure displayed in the target frame image. The reason for extracting the target area is that there may be areas showing non-chip structures on the target frame image. These areas will interfere with the subsequent calculation of the mapping relationship and thus need to be excluded, and only the target area that displays the target structure is acquired. In related technologies, the developer usually takes a plurality of target frame images, with each target frame image displaying a part of the chip structure, and then compares the target frame images with the manufacturing specification used in chip manufacturing. The design parameters of each component in the chip are written in the manufacturing specification, such as the resistance value of the resistor, the inductive reactance of the inductor, the capacitive reactance of the capacitor, the cut-off voltage of the diode and the transistor, the on/off state of each component during normal operation, the voltage and current carried by each component, etc. The developer compares the plurality of target frame images with the manufacturing specification to understand the operating principle and operating process of the manufactured chip. The manufacturing specification is often long and is a textual introduction, which is difficult for the developer to understand, thereby reducing the efficiency of secondary development based on the chip and the efficiency of verifying whether the chip conforms to the manufacturing specification.

S13: Determining a mapping relationship between the target structure and the circuit model

S14: Generating and displaying, according to the mapping relationship and the target structure, a target circuit model corresponding to the target structure.

Specifically, as mentioned above, the target structure is a part of the chip structure, and the chip structure corresponds to the circuit model. Therefore, the target structure corresponds to a part of the circuit model, and the circuit model of the part corresponding to the chip structure is the target circuit model. The circuit model is drawn based on the chip structure. The parameters in the circuit model are the same as the geometry size of the chip structure, but the angle used to draw the circuit model is usually different from the angle used to take the target frame image. It can be simply understood as follows: when making the circuit model, camera A is used to photograph the chip structure, camera A automatically generates, according to the chip structure, a circuit model diagram of the same scale as the chip structure, and the picture taken by camera A is the circuit model diagram; camera B is used when taking the target frame image; although camera A and camera B photograph the same chip structure, the positions of camera A and camera B are different when they take photos, the circuit model in camera A must be translated and rotated to be able to corresponds to the chip structure in the target frame image taken by camera B; the specific translation direction, translation distance, rotation direction, and rotation angle are the mapping relationship between the target structure and the circuit model, and this mapping relationship can be expressed by a matrix, which is usually called model view matrix in graphics. After determining the mapping relationship, we know how to translate and rotate the circuit model, and after said translation and rotation, the circuit model seen by the developer will be in an angle of view being same as the angle used when the target frame image was taken, at this time, only the target circuit model corresponding to the target structure is shown. In the disclosure, after the target circuit model is generated, only the target circuit model is displayed to the user, or the target circuit model can be displayed to the user in the target area of the target frame image. Compared with the taken target frame image, the established circuit model is better understood, especially when the name and symbol of each component, as well as the physical parameters of each component are displayed on the circuit model, which is convenient for the developer to understand, thereby improving the efficiency of secondary development based on the chip and the verification efficiency of chip verification. That is, the disclosure adopts the augmented reality technology to display the circuit model corresponding to the target structure in the target frame image, so as to facilitate the understanding of the operating principle of the chip. When viewing the target frame image in related technologies, the chip structure is not easy to understand. By displaying the target circuit model, the disclosure facilitates people to understand the operating principle of the chip, and the chip development efficiency and chip verification efficiency are improved.

Optionally, determining a mapping relationship between the target structure and the circuit model, including:

capturing a plurality of first feature points from the circuit model as a first point group;

capturing a plurality of second feature points from the target structure as a second point group;

matching the first point group and the second point group using feature points matching algorithm to determine a model view matrix between the target structure and the circuit model; and

characterizing the mapping relationship between the target structure and the circuit model with the model view matrix.

Specifically, capturing a plurality of first feature points refers to determining each first feature point, and then determining the coordinates of the first feature points on the circuit model diagram, and the first point group refers to the set of coordinates of the first feature points on the circuit model diagram. In the same way, the second point group refers to the set of coordinates of the second feature points on the target frame image. It should be noted that the image coordinate system of the target frame image and the image coordinate system of the circuit model diagram are preferably the same, that is, the directions of the abscissas are the same, the directions of the ordinates are the same, the scales are the same, and the coordinate origins are at the same position, for example, the coordinate origins of the image coordinate systems are set at the upper left corners of the images. The first feature points and the second feature points are preferably the circuit intersection points of the chip structure, that is, the cross connection points of two connecting wires in the chip structure, because although the circuit model is an isometric three-dimensional schematic diagram of the chip structure, the size of each component in the circuit model may be slightly different from that in the real chip structure, and the coordinates of the connection points of two wires, that is, the circuit intersection points, are usually easier to determine and the error is smaller. The set of the first feature points can be regarded as a first curved surface, and the set of the second feature points can be regarded as a second curved surface. Since the circuit model and chip structure are the same, the second curved surface must overlap with a part of the first curved surface. To overlap the second curved surface with the first curved surface, it is necessary to translate, rotate, and scale the second curved surface. The feature points matching algorithm is adopted to align two overlapping curved surfaces, where the feature points matching algorithm preferably adopts ICP algorithm (Iterative Closest Point, iterative closest point algorithm), the specific calculation process is a related technology and will not be repeated in this disclosure. The final mapping relationship obtained is represented by a model view matrix (MVM), that is, the translation & rotation (RT) matrix between the second point group and the first point group. The model view matrix is used to map the points on the circuit model diagram to the target frame image, and the coordinates of any pixel in the circuit model of the circuit model diagram pre-multiply the model view matrix to get the coordinates of the pixel on the target frame image. After obtaining the MVM matrix, we can determine how to project the circuit model from the circuit model diagram to the target frame image.

Optionally, capturing a plurality of second feature points from the target structure as a second point group includes: converting the target frame image into a grayscale image, and capturing the plurality of second feature points from the target structure displayed in the grayscale image as the second point group. Specifically, the purpose of converting the target frame image into a grayscale image is to facilitate the capture of the second feature points.

Optionally, generating and displaying, according to the mapping relationship and the target structure, a target circuit model corresponding to the target structure includes:

acquiring an original circuit model corresponding to the target structure from the circuit model diagram;

performing, according to the mapping relationship, affine transformation on the original circuit model to obtain target coordinates of each point of the original circuit model on the view plane of the target frame image; and

generating and displaying, according to the target coordinates, the target circuit model corresponding to the target structure.

Specifically, the entire chip structure corresponds to the entire circuit model, and the target structure may only be a part of the chip structure. The original circuit model refers to the circuit model corresponding to the chip structure. For example, when the target structure is the left half of the chip structure, the original circuit model is the left half of the circuit model, and then the coordinates of each point of the original circuit model on the plane of the target frame image are calculated according to the mapping relationship, so as to reconstruct a target circuit model. Since the original circuit model can be an isometric schematic diagram of the target structure, the components in the circuit model can be identified with well-understood physical graphic symbols (for example, the corresponding physical symbols are drawn on top of the components), and each component in the circuit model displays the corresponding physical parameters, for example, the resistance value is displayed on the resistor, and the inductive reactance is displayed on the inductor, therefore, it is convenient for users to understand the principle of the chip structure clearly and simply.

Optionally, the method provided in the disclosure further includes: displaying one or more of current information, voltage information, resistance information, and on/off state of the switch during operation of the target structure on the target circuit model. Specifically, the current information includes the magnitude and direction of the current. For example, a moving arrow can be adopted to display the flow direction of the current on the target circuit model to dynamically display the movement process of the current. The voltage information includes the magnitude of the voltage, and the voltage value between two ends of any component in the chip structure.

The method provided in the disclosure can be applied to AR devices. When a user views the taken target frame image using an AR device, the corresponding target circuit model is displayed in the target frame image, such that the user can directly carry out chip development work without reading hundreds of pages of textual manufacturing specification, and it is convenient to verify whether the manufactured chip conforms to the manufacturing specification.

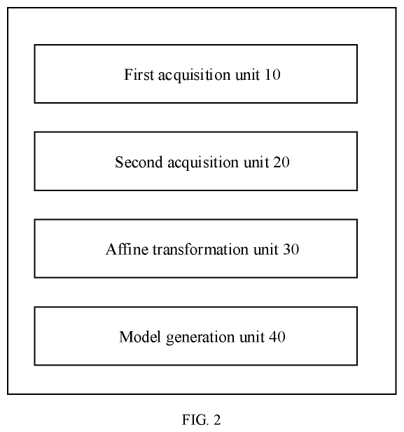

As shown in FIG. 2, the disclosure further provides an augmented reality display device for a chip structure, including: a first acquisition unit 10, a second acquisition unit 20, an affine transformation unit 30 and a model generation unit 40.

The first acquisition unit 10 is configured to acquire a circuit model diagram corresponding to the chip structure, and the circuit model diagram displays a three-dimensional circuit model thereon.

The second acquisition unit 20 is configured to acquire a target frame image and capture, from the target frame image, a target area displaying a target structure, and the target structure is a part or all of the chip structure displayed in the target frame image.

The affine transformation unit 30 is configured to determine a mapping relationship between the target structure and the circuit model.

The model generation unit 40 is configured to generate and display, according to the mapping relationship and the target structure, a target circuit model corresponding to the target structure.

Specifically, the target frame image here is any photo of the internal structure of a chip manufactured in the real environment, and the chip has the chip structure described in the disclosure. Therefore, a part or all of the chip structure must be displayed on the photographed target frame image. The target area is the area where the chip structure is displayed, and the chip structure displayed in the target frame image is referred to as the target structure in the disclosure, that is, the target structure is a part or all of the chip structure displayed in the target frame image. The circuit model is drawn based on the chip structure. The parameters in the circuit model are the same as the geometry size of the chip structure, but the angle used to draw the circuit model is usually different from the angle used to take the target frame image. Therefore, it is necessary to use the affine transformation unit 30 to determine the mapping relationship, so as to perform affine transformation on the circuit model. The model generation unit 40 may only display the target circuit model, or display the target circuit model in the target area of the target frame image. Compared with the taken target frame image, the established circuit model is better understood, especially when the name and symbol of each component in the chip structure, as well as the physical parameters of each component in the chip structure are displayed on the circuit model, which is convenient for the developer to understand, thereby improving the efficiency of secondary development based on the chip and the verification efficiency of chip verification. The device provided in the disclosure may be an AR display device. The model generation unit 40 includes a display for displaying the target frame image and the target circuit model. After the target frame image is loaded, the model generation unit 40 displays the corresponding circuit model diagram on the target structure of the target frame image, or draws a selection box on the target frame image for marking the recognized target area and displays the circuit model corresponding to the target structure on one side of the target area to facilitate users to compare the target structure and the target circuit model. That is, in the disclosure, the augmented reality technology can be adopted to display the circuit model corresponding to the target structure in the target frame image, so as to facilitate the understanding of the operating principle of the chip.

Optionally, determining, by the affine transformation unit 30, a mapping relationship between the target structure and the circuit model, including:

capturing a plurality of first feature points from the circuit model as a first point group;

capturing a plurality of second feature points from the target structure as a second point group;

matching the first point group and the second point group using feature points matching algorithm to determine a model view matrix between the target structure and the circuit model; and

characterizing the mapping relationship between the target structure and the circuit model with the model view matrix.

Specifically, capturing a plurality of first feature points refers to determining each first feature point, and then determining the coordinates of the first feature points on the circuit model diagram, and the first point group refers to the set of coordinates of the first feature points on the circuit model diagram. In the same way, the second point group refers to the set of coordinates of the second feature points on the target frame image. It should be noted that the image coordinate system of the target frame image and the image coordinate system of the circuit model diagram are preferably the same, that is, the directions of the abscissas are the same, the directions of the ordinates are the same, the scales are the same, and the coordinate origins are at the same position, for example, the coordinate origins of the image coordinate systems are set at the upper left corners of the images. The first feature points and the second feature points are preferably the circuit intersection points of the chip structure, that is, the cross connection points of two connecting wires in the chip structure, because although the circuit model is an isometric three-dimensional schematic diagram of the chip structure, the size of each component in the circuit model may be slightly different from that in the real chip structure, and the coordinates of the connection points of two wires, that is, the circuit intersection points, are usually easier to determine and the error is smaller. After obtaining the MVM matrix, we can determine how to project the circuit model from the circuit model diagram to the target frame image.

Optionally, capturing, by the affine transformation unit 30, a plurality of second feature points from the target structure as a second point group includes: converting the target frame image into a grayscale image, and capturing the plurality of second feature points from the target structure displayed in the grayscale image as the second point group.

Optionally, generating, by the model generation unit 40, a target circuit model corresponding to the target structure according to the mapping relationship and the target structure includes:

acquiring an original circuit model corresponding to the target structure from the circuit model diagram;

performing, according to the mapping relationship, affine transformation on the original circuit model to obtain target coordinates of each point of the original circuit model on the view plane of the target frame image; and

generating, according to the target coordinates, the target circuit model corresponding to the target structure.

Specifically, the entire chip structure corresponds to the entire circuit model, and the target structure may only be a part of the chip structure. The original circuit model refers to the circuit model corresponding to the chip structure. Since the original circuit model can be an isometric schematic diagram of the target structure, the components in the circuit model can be identified with well-understood physical graphic symbols, and each component in the circuit model displays the corresponding physical parameters, for example, the resistance value is displayed on the resistor, and the inductive reactance is displayed on the inductor, therefore, it is convenient for users to understand the principle of the chip structure clearly and simply.

Optionally, the device provided in the disclosure further includes an analog circuit unit, configured to display one or more of current information, voltage information, resistance information, and on/off state of the switch during operation of the target structure on the target circuit model. Specifically, the current information includes the magnitude and direction of the current. For example, a moving arrow can be adopted to display the flow direction of the current on the target circuit model to dynamically display the movement process of the current. The voltage information includes the magnitude of the voltage, and the voltage value between two ends of any component in the chip structure.

The disclosure further provides a readable storage medium, a computer program is stored therein and configured to perform, when executed by a processor, steps in any one of the methods provided in the disclosure.

The above descriptions are only preferred embodiments of this disclosure, and are not intended to limit the disclosure. For those of ordinary skill in the art, the disclosure may have various modifications and variations. Any modifications, equivalent replacements, and improvements made within the spirit and principle of this disclosure shall be included in the protection scope of this disclosure.

1. An augmented reality display method for a chip structure, comprising:
acquiring a circuit model diagram corresponding to the chip structure, the circuit model diagram displaying a three-dimensional circuit model;
acquiring a target frame image and capturing, from the target frame image, a target area displaying a target structure, the target structure being a part or all of the chip structure displayed in the target frame image;
determining a mapping relationship between the target structure and the circuit model; and
generating and displaying, according to the mapping relationship and the target structure, a target circuit model corresponding to the target structure.

2. The augmented reality display method for the chip structure as claimed in claim 1, wherein the determining a mapping relationship between the target structure and the circuit model comprises:
capturing a plurality of first feature points from the circuit model as a first point group;
capturing a plurality of second feature points from the target structure as a second point group;
matching the first point group and the second point group using feature points matching algorithm to determine a model view matrix between the target structure and the circuit model; and
characterizing the mapping relationship between the target structure and the circuit model with the model view matrix.

3. The augmented reality display method for the chip structure as claimed in claim 2, wherein the capturing a plurality of second feature points from the target structure as a second point group comprises:
converting the target frame image into a grayscale image, and capturing the plurality of second feature points from the target structure displayed in the grayscale image as the second point group.

4. The augmented reality display method for the chip structure as claimed in claim 1, wherein the generating and displaying, according to the mapping relationship and the target structure, a target circuit model corresponding to the target structure comprises:
acquiring an original circuit model corresponding to the target structure from the circuit model diagram;
performing, according to the mapping relationship, affine transformation on the original circuit model to obtain target coordinates of each point of the original circuit model on the view plane of the target frame image; and
generating and displaying, according to the target coordinates, the target circuit model corresponding to the target structure.

5. The augmented reality display method for the chip structure as claimed in claim 1, further comprising:
displaying one or more of current information, voltage information, resistance information, and on/off state of a switch during operation of the target structure on the target circuit model.

6. An augmented reality display device for a chip structure, comprising:
a first acquisition unit, configured to acquire a circuit model diagram corresponding to the chip structure, the circuit model diagram displaying a three-dimensional circuit model;
a second acquisition unit, configured to acquire a target frame image and capture, from the target frame image, a target area displaying a target structure, the target structure being a part or all of the chip structure displayed in the target frame image;
an affine transformation unit, configured to determine a mapping relationship between the target structure and the circuit model; and
a model generation unit, configured to generate and display, according to the mapping relationship and the target structure, a target circuit model corresponding to the target structure.

7. The augmented reality display device for the chip structure as claimed in claim 6, wherein determining, by the affine transformation unit, a mapping relationship between the target structure and the circuit model comprises:
capturing a plurality of first feature points from the circuit model as a first point group;
capturing a plurality of second feature points from the target structure as a second point group;
matching the first point group and the second point group using feature points matching algorithm to determine a model view matrix between the target structure and the circuit model; and
characterizing the mapping relationship between the target structure and the circuit model with the model view matrix.

8. The augmented reality display device for the chip structure as claimed in claim 7, wherein capturing, by the affine transformation unit, a plurality of second feature points from the target structure as a second point group comprises:
converting the target frame image into a grayscale image, and capturing the plurality of second feature points from the target structure displayed in the grayscale image as the second point group.

9. The augmented reality display device for the chip structure as claimed in claim 6, wherein generating and displaying, by the model generation unit, a target circuit model corresponding to the target structure according to the mapping relationship and the target structure comprises:
acquiring an original circuit model corresponding to the target structure from the circuit model diagram;
performing, according to the mapping relationship, affine transformation on the original circuit model to obtain target coordinates of each point of the original circuit model on the view plane of the target frame image; and
generating and displaying, according to the target coordinates, the target circuit model corresponding to the target structure.

10. The augmented reality display device for the chip structure as claimed in claim 6, further comprising:
an analog circuit unit, configured to display one or more of current information, voltage information, resistance information, and on/off state of a switch during operation of the target structure on the target circuit model.

11. A readable storage medium having a computer program stored therein, wherein the computer program, when executed by a processor, causes the processor to perform the augmented reality display method as claimed in claim 1.

12. The readable storage medium as claimed in claim 11, wherein the determining a mapping relationship between the target structure and the circuit model comprises:
capturing a plurality of first feature points from the circuit model as a first point group;
capturing a plurality of second feature points from the target structure as a second point group;
matching the first point group and the second point group using feature points matching algorithm to determine a model view matrix between the target structure and the circuit model; and
characterizing the mapping relationship between the target structure and the circuit model with the model view matrix.

13. The readable storage medium as claimed in claim 12, wherein the capturing a plurality of second feature points from the target structure as a second point group comprises:
converting the target frame image into a grayscale image, and capturing the plurality of second feature points from the target structure displayed in the grayscale image as the second point group.

14. The readable storage medium as claimed in claim 11, wherein the generating and displaying, according to the mapping relationship and the target structure, a target circuit model corresponding to the target structure comprises:
acquiring an original circuit model corresponding to the target structure from the circuit model diagram;
performing, according to the mapping relationship, affine transformation on the original circuit model to obtain target coordinates of each point of the original circuit model on the view plane of the target frame image; and
generating and displaying, according to the target coordinates, the target circuit model corresponding to the target structure.

15. The readable storage medium as claimed in claim 11, wherein the augmented reality display method for the chip structure further comprises:
displaying one or more of current information, voltage information, resistance information, and on/off state of a switch during operation of the target structure on the target circuit model.
